(19) United States
(12) Patent Application Publication
(10) Pub. No.: US 2014/0128085 A1
(43) Pub. Date: May 8, 2014

(54) COMMON SEARCH SPACE CONFIGURATION OF A CARRIER

(71) Applicant: RENESAS MOBILE CORPORATION, Tokyo (JP)

(72) Inventor: Gilles CHARBIT, Farnborough (GB)

(73) Assignee: RENESAS MOBILE CORPORATION, Tokyo (JP)

(21) Appl. No.: 14/062,426

(22) Filed: Oct. 24, 2013

(30) Foreign Application Priority Data
Nov. 2, 2012 (GB) 1219719.0

(51) Int. Cl. H04W 28/18

(52) U.S. Cl. CPC H04W 28/18
USPC 455/450

(57) ABSTRACT

Measures for a common search space configuration of a standalone carrier may exemplarily include measures for configuring a common search space for an enhanced physical downlink control channel of a carrier, and measures for scheduling a master information block of common control signaling on a physical broadcast channel of the carrier, wherein said master information block indicates a configuration of the common search space which defines a set of pairs of physical resource blocks in the common search space.

### CROSS REFERENCE TO RELATED APPLICATION

This application claims the benefit under 35 U.S.C. §119(a) and 37 CFR §1.55 to UK Patent Application No. 1219719.0, filed on Nov. 2, 2012, the entire content of which is incorporated herein by reference.

### TECHNICAL FIELD

The present invention relates to common search space configuration of a standalone carrier. More specifically, the present invention relates to measures (including methods, apparatuses and computer program products) for realizing a common search space configuration of a standalone carrier.

### BACKGROUND

In the development of cellular communication systems, a focus is on increasing bandwidth and throughput in the radio access network, while enhancing system coverage and performance. In this regard, the concept of carrier aggregation (CA) has been developed.

In carrier aggregation, multiple component carriers (which may be referred to as legacy carriers) are combined as a primary component carrier (PCC) and at least one secondary component carrier (SCC). In such combination of aggregated (legacy) component carriers, the PCC has to have means for the provision of system information, paging and random access procedures, e.g. a broadcast channel (BCH) and a common search space (CSS) for an enhanced physical downlink control channel (ePDCCH).

In the development of carrier aggregation, a new type of carrier is considered to be desirable, which is non-backwards compatible, i.e. which does not include any backwards compatible elements. Such new carrier type (NCT) could provide for CA enhancements, as the support of legacy terminals would not be required.

While such new carrier type for CA may be required to be aggregated with a legacy carrier as a primary carrier which enables the provision of system information, it is preferable that such new carrier type for CA is operable as a standalone carrier, i.e. a carrier which is not required to be aggregated with a legacy carrier as a primary carrier. Such standalone carrier, which could thus not be assumed to be aggregated with a legacy carrier, would have to have its own means for the provision of system information, paging and random access procedures, e.g. a broadcast channel (BCH) and a common search space (CSS) for an enhanced physical downlink control channel (ePDCCH).

The present specification relates to an appropriate configuration of a common search space (CSS) for an enhanced physical downlink control channel (ePDCCH) of a carrier, which may for example be such new LTE/LTE-A carrier type applicable for carrier aggregation, in view of the subsequent considerations.

Recently, the CSS configuration of a legacy carrier is based on combined handling/consideration of the physical downlink control channel (PDCCH) and the enhanced physical downlink control channel (ePDCCH) of such carrier. Namely, a UE is assumed to monitor Common Search Space (CSS) and UE-specific Search Space (USS) on the PDCCH (e.g. according to LTE Rel-10 behavior) in subframes not configured for monitoring the ePDCCH (e.g. according to LTE Rel-11 behavior). The PDCCH requires Rel-8 Cell-specific Reference Signals (CRS), and CRS-based carrier tracking is assumed to be supported by way of a Reduced Cell-specific Reference Signal (RCRS) on a new carrier type, at least for the unsynchronized case. By unsynchronized case, it is meant that the NCT cannot re-use synchronization from an aggregated legacy carrier. This assumption also applies to a standalone NCT, since the UE must be able to synchronize to it independently from other carriers.

Specifically, as the Reduced Cell-specific Reference Signal (RCRS), the NTC an carry 1 RS port (consisting of the Rel-8 CRS Port 0 REs per Physical Resource Block (PRB) and Rel-8 sequence) within 1 subframe with 5 ms periodicity, wherein this RS port is not used for demodulation.

If the RCRS is scheduled on a standalone NCT, then the Rel-8 PDCCH cannot use the RCRS for demodulation. Hence, use of other reference signals for PDCCH demodulation such as Rel-10 UE-specific Demodulation Reference Signals (DM RS) could be considered. However, this would require use of the same antenna port mapping for Rel-8 PDCCH and PDSCH across all Physical Resource Blocks (PRBs). In this regard, it is to be noted that Rel-8 PDCCH design includes a sub-block interleaver for mapping of Control Channel Elements (CCE) to Resource Element Groups (REG) scattered across the whole bandwidth. This would make use of Transmit Mode #9 for Multi-User MIMO based on Rel-10 DM RS not practical. Thus, using DM RS for PDCCH demodulation is not a preferable approach.

Rather, a more preferable approach could be not to have the (Rel-8/9/10) PDCCH on a standalone NCT and only use the (Rel-11) ePDCCH. Accordingly, the CSS configuration of a standalone NCT would have to be based on handling/consideration of ePDCCH of such carrier only.

If the ePDDCH is used, it is to be noted that the ePDCCH typically uses antenna ports #107, . . . , #109 based on Rel-10 UE-specific Demodulation Reference Signals (DM RS) for demodulation. Further, in Rel-11, Common Search Space (CSS), UE-Specific Search Space (USS), antenna port mapping and resource allocation for the ePDCCH are configured by the eNB via dedicated signaling. However, such dedicated signaling takes place on the Downlink Shared Channel (DL-SCH) and hence requires use of the PDCCH and the PDSCH. Thus, such approach is not practicable without using the (Rel-8/9/10) PDCCH on a standalone NCT.

Therefore, for example, there is a demand for a solution to enable configuring the search spaces, antenna port mapping and resource allocation for the ePDCCH, which is equally applicable for a new carrier type of a standalone carrier which requires its own configuration.

As a CSS configuration could build the basis for further configurations, there is a need for an advanced configuration of a common search space for an enhanced physical downlink control channel of a standalone carrier.

### SUMMARY

Various exemplary embodiments of the present invention aim at addressing at least part of the above issues and/or problems and drawbacks.

Various aspects of exemplary embodiments of the present invention are set out in the appended claims.

According to an exemplary aspect of the present invention, there is provided a method including configuring a common search space for an enhanced physical downlink control channel of a carrier, and scheduling a master information block of common control signaling on a physical broadcast channel of the carrier, wherein said master information block indicates a configuration of the common search space which defines a set of pairs of physical resource blocks in the common search space.

According to an exemplary aspect of the present invention, there is provided a method including monitoring a master information block of common control signaling on a physical broadcast channel of a carrier, wherein said master information block indicates a configuration of a common search space which defines a set of pairs of physical resource blocks in the common search space, and detecting the common search space for an enhanced physical downlink control channel of the carrier on the basis of the configuration of the common search space indicated in the monitored master information block.

According to an exemplary aspect of the present invention, there is provided an apparatus (which may e.g. be arranged/configured for use on a network side of a cellular communication system), including a processing system arranged to cause the apparatus to perform: configuring a common search space for an enhanced physical downlink control channel of a carrier, and scheduling a master information block of common control signaling on a physical broadcast channel of the carrier, wherein said master information block indicates a configuration of the common search space which defines a set of pairs of physical resource blocks in the common search space.

According to an exemplary aspect of the present invention, there is provided an apparatus (which may e.g. be arranged/configured for use on a terminal side of a cellular communication system), including a processing system arranged to cause the apparatus to perform: monitoring a master information block of common control signaling on a physical broadcast channel of a carrier, wherein said master information block indicates a configuration of a common search space which defines a set of pairs of physical resource blocks in the common search space, and detecting the common search space for an enhanced physical downlink control channel of the carrier on the basis of the configuration of the common search space indicated in the monitored master information block.

The processing system according to any one of the aforementioned apparatus-related exemplary aspects of the present invention may for example include at least one processor and at least one memory including computer program code (and, optionally, at least one transceiver or interface configured for communication with at least another apparatus), wherein the at least one processor, with the at least one memory and the computer program code, is arranged/configured to cause the apparatus to perform as described herein.

According to an exemplary aspect of the present invention, there is provided an apparatus including means for configuring a common search space for an enhanced physical downlink control channel of a carrier, and means for scheduling a master information block of common control signaling on a physical broadcast channel of the carrier, wherein said master information block indicates a configuration of the common search space which defines a set of pairs of physical resource blocks in the common search space.

According to an exemplary aspect of the present invention, there is provided an apparatus including means for monitoring a master information block of common control signaling on a physical broadcast channel of a carrier, wherein said master information block indicates a configuration of a common search space which defines a set of pairs of physical resource blocks in the common search space, and means for detecting the common search space for an enhanced physical downlink control channel of the carrier on the basis of the configuration of the common search space indicated in the monitored master information block.

According to an exemplary aspect of the present invention, there is provided a computer program product including a set of instructions (e.g. computer-executable computer program code) which, when executed on an apparatus or a computer of an apparatus (e.g. an apparatus according to any one of the aforementioned apparatus-related exemplary aspects of the present invention), is arranged/configured to cause the computer or apparatus to carry out the method according to any one of the aforementioned method-related exemplary aspects of the present invention.

Such computer program product may for example include or be embodied as a (tangible) computer-readable (storage) medium or the like on which the computer-executable computer program code is stored, and/or the program may be directly loadable into an internal memory of the computer or a processor thereof.

Advantageous further developments or modifications of the aforementioned exemplary aspects of the present invention are set out in the following.

By virtue of the aforementioned exemplary aspects of the present invention, there is provided an advanced configuration of a common search space for an enhanced physical downlink control channel of a standalone carrier.

Accordingly, there is provided a common search space configuration of a standalone carrier, which is effective and efficient. Such common search space configuration is applicable for a standalone carrier/operation of a non-backwards compatible LTE/LTE-A carrier type for carrier aggregation.

Thus, for example, improvements may be achieved by methods, apparatuses and computer program products capable of enabling/realizing an advanced configuration of a common search space for an enhanced physical downlink control channel of a standalone carrier.

### BRIEF DESCRIPTION OF DRAWINGS

For a more complete understanding of some example embodiments of the present invention, reference is now made to the following description taken in connection with the accompanying drawings in which:

FIG. 1 shows a signaling diagram illustrating a first example procedure of according to some example embodiments of the present invention,

FIG. 2 shows a signaling diagram illustrating a second example procedure of according to some example embodiments of the present invention,

FIG. 3 shows a signaling diagram illustrating a third example procedure of according to some example embodiments of the present invention, and

FIG. 4 shows a schematic block diagram illustrating example apparatuses according to some example embodiments of the present invention.

### DETAILED DESCRIPTION

Exemplary aspects of the present invention will be described herein below. More specifically, some exemplary aspects of the present are described hereinafter with reference to particular non-limiting examples and to what are presently considered to be conceivable embodiments of the present invention. A person skilled in the art will appreciate that the invention is by no means limited to these examples, and may be more broadly applied.

It is to be noted that the following description of the examples and example embodiments of the present invention mainly refers to specifications being used as non-limiting examples for certain exemplary network configurations and deployments. Namely, the present invention and its embodiments are mainly described in relation to 3GPP specifications being used as non-limiting examples for certain exemplary network configurations and deployments. In particular, a LTE/LTE-A communication system is used as a non-limiting example for the applicability of thus described exemplary embodiments. As such, the description of exemplary embodiments given herein specifically refers to terminology which is directly related thereto. Such terminology is only used in the context of the presented non-limiting examples, and does naturally not limit the invention in any way. Rather, any other network configuration or system deployment, etc. may also be utilized as long as compliant with the features described herein.

In particular, some example embodiments of the present invention may be applicable in any communication system and/or network deployment in which carrier/channel aggregation is or could be applicable. Such communication system and/or network deployment could for example include those in accordance with IEEE 802.11. For example, application to an IEEE 802.11 ah system could be conceivable, which supports 1 MHz, 2 MHz, 4 MHz, 8 MHz, and 16 MHz channel bandwidths and OFDM PHY with 31.25 kHz tone spacing, wherein there could be adopted carrier aggregation (or channel aggregation).

Hereinafter, various embodiments and implementations of the present invention and its aspects or embodiments are described using several alternatives. It is generally noted that, according to certain needs and constraints, all of the described alternatives may be provided alone or in any conceivable combination (also including combinations of individual features of the various alternatives).

According to example embodiments of the present invention, in general terms, there are provided mechanisms, measures and means for enabling/realizing an advanced configuration of a common search space for an enhanced physical downlink control channel of a standalone carrier.

In the following, example embodiments of the present invention are described with reference to methods, procedures and functions, as well as with reference to structural arrangements and configurations.

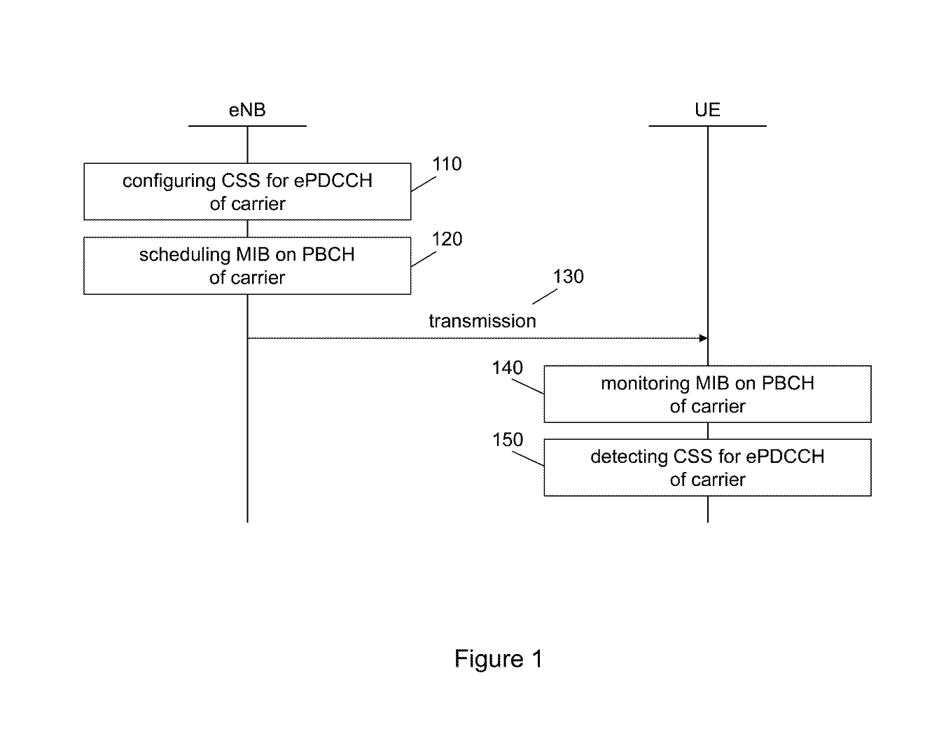

FIG. 1 shows a signaling diagram illustrating a first example procedure of according to some example embodiments of the present invention.

As shown in FIG. 1, an example procedure according to some example embodiments of the present invention may include the following operations. The thus exemplified procedure is applicable between a base station such as an eNB and a terminal such as an UE in a cellular communication system such as a LTE/LTE-A communication system.

At the network side, the eNB configures a common search space (CSS) for an enhanced physical downlink control channel (ePDCCH) of a carrier (operation 110), and schedules a master information block (MIB) of common control signaling (such as system information) on a physical broadcast channel (PBCH) of the carrier (operation 120), wherein said master information block indicates a configuration of the common search space which defines a set of pairs of physical resource blocks (PRBs) in the common search space. Then, a transmission from the eNB to the UE may be accomplished using the PBCH of the carrier (operation 130). At the terminal side, the UE monitors the master information block (MIB) of common control signaling (such as system information) on the physical broadcast channel (PBCH) of the carrier (operation 140), and detects the common search space (CSS) for the enhanced physical downlink control channel (ePDCCH) of the carrier on the basis of the configuration of the common search space indicated in the monitored master information block (operation 150).

According to some example embodiments of the present invention, the CSS configuration, i.e. the definition of the PRB pair set, could include a number of PRBs in the PRB pair set in the CSS or such PRB number and a mapping of localized or distributed eCCEs (i.e. control channel elements of the ePDCCH) to said PRB pairs in the CSS. Accordingly, the eNB could configure and the UE could detect such definition of the PRB pair set, including a number of PRBs in the PRB pair set in the CSS or such PRB number and a mapping of localized or distributed eCCEs (i.e. control channel elements of the ePDCCH) to said PRB pairs in the CSS.

According to some example embodiments of the present invention, the CSS configuration, i.e. the definition of the PRB pair set, could be specified on a cell basis on the basis of a cell configuration. For example, the CSS for the ePDCCH on the carrier may be configured on the basis of a physical cell identity (PCI) with or without consideration of the system bandwidth (or a number of PRB subsets in the system bandwidth). Such CSS configuration may result in a coordination of common search spaces.

Namely, using a cell configuration such as the physical cell identity being assigned by/in the E-UTRAN, a coordination of CSS configurations between multiple cells/eNBs is enabled. Thereby, inter-cell interference on the common control signaling between such cells/eNBS may be mitigated. The E-UTRAN may assign, or in the E-UTRAN there may be assigned, physical cell identities to multiple (neighboring) cells to ensure that their CSS configurations (and their MIB/SIB transmissions) are multiplexed in the frequency domain, i.e. contained in different PRB (sub-)sets, as much as can be. In this regard, configuration of the ePDCCH CSS can be coordinated between multiple eNBs to limit inter-cell interference to the ePDCCH in the CSS.

It is noted that an assignment of physical cell identities to eNBs in/by the E-UTRAN may be accomplished by an OAM function or entity in/of the E-UTRAN. In general terms, PCI assignment may be centralized, i.e. the OAM function or entity may specifically assign and signal a specific PCI value to each eNB, or PCI assignment may be distributed, i.e. the OAM function or entity may signal a list of potential PCI value to each eNB and each eNB may select its PCI value from the list of potential PCI values given by the OAM function or entity based on some criterion (such as e.g. UE reports, X2 interface reports, some dedicated acquisition technique, or the like).

As the CSS configuration is indicated (in the aforementioned MIB) on the PBCH (which is located in the first subframne, i.e. subframe 0, of each radio frame), no dedicated signaling thereof (e.g. on the PDSCH) is required.

According to some example embodiments of the present invention, the aforementioned MIB could be constructed as follows, using Abstract Syntax Notation One (ASN.1).

| | |
|---|---|
| -- ASN1START | |
| MasterInformationBlock ::= | SEQUENCE { |
| dl-Bandwidth | ENUMERATED { |
| | n6, n15, n25, n50, n75, n100}, |
| phich-Config | PHICH-Config, |
| systemFrameNumber | BIT STRING (SIZE (8)), |
| CSS-Config | BIT STRING (SIZE (x)) |
| SPARE | BIT STRING (SIZE (y)) |
| } | |
| -- ASN1STOP | |

The information element “dl-Bandwidth” defines a transmission bandwidth configuration in units of resource blocks, i.e. N_{RB} on the downlink, as specified in 3GPP TS 36.101. Thereby, n6 corresponds to 6 resource blocks, n15 to 15 resource blocks, and so on.

The information element “phich-Config” defines a PHICH configuration, including duration and resources.

The information element “systemFrameNumber” defines the 8 most significant bits of the system frame number (SFN), as specified in 3GPP TS 36.211. One value applies for all serving cells (the associated functionality is common i.e. not performed independently for each cell).

The information element “CSS-Config” indicates the CSS configuration. Namely, it defines the PRB pair set using 5 or 6 bits. As detailed below, such definition could for example be based on the system bandwidth and the eCCE mapping to PRB pairs (localized or distributed).

Accordingly, the MIB according to some example embodiments of the present invention utilizes a (part of a) spare field in a conventional MIB structure, e.g. as specified in 3GPP TS 36.331 (V 11.1.0). As compared with a conventional (Rel-8/9/19) MIB, which contains a spare field of 10 bits, x bits (x=5 or 6) are utilized for the CSS indication, thus retaining y (y=5 or 4) spare bits.

According to some example embodiments of the present invention, the aforementioned CSS-Config information element in the MIB could be constructed as follows, using Abstract Syntax Notation One (ASN.1).

In a first option, the indication of the CSS configuration in the MIB could define a number of PRBs in the PRB pair set in the CSS. To this end, 5 bits could be used.

| | |
|---|---|
| -- ASN1START | |
| CSS-Config ::= | SEQUENCE { |
| CSS-Resource | BIT STRING (SIZE (5)) |
| } | |
| -- ASN1STOP | |

The parameter “CSS-Resource” indicates the number of PRBs in the PRB pair set, i.e. PRB pair set indices. Example values could be ‘00001’ for 1 PRB, ‘00010’ for 2 PRBs, ‘00100’ for 4 PRBs, ‘01000’ for 8 PRBs, and ‘10000’ for 16 PRBs (based on currently valid working assumptions).

In a second option, the indication of the CSS configuration in the MIB could define a number of PRBs in the PRB pair set in the CSS and a mapping of localized or distributed eCCEs (i.e. control channel elements of the ePDCCH) to the PRB pairs in the CSS. To this end, 5 bits could be used for the former, and 1 bit could be used for the latter, thus resulting in a total of 6 bits.

| | |
|---|---|
| -- ASN1START | |
| CSS-Config ::= | SEQUENCE { |
| CSS-Resource | BIT STRING (SIZE (5)) |
| CSS-eCCEmappingtoPRB | BIT STRING (SIZE (1)) |
| } | |
| -- ASN1STOP | |

The parameter “CSS-Resource” indicates the number of PRBs in the PRB pair set, i.e. PRB pair set indices. Example values could be ‘00001’ for 1 PRB, ‘00010’ for 2 PRBs, ‘00100’ for 4 PRBs, ‘01000’ for 8 PRBs, and ‘10000’ for 16 PRBs (based on currently valid working assumptions).

The parameter “CSS-eCCEmappingtoPRB” indicates a mapping of eCCE to PRB pairs (localized eCCE or distributed eCCE). It represents a flag indicating distributed eCCE mapping to PRB pairs, if ‘0’, or localized eCCE mapping to PRB pairs, if ‘1’, for example. In this regard, 16 eREGs within a PRB pair in both normal and special subframes could be interleaved and then mapped to REs in frequency-first order. Further, at least for normal subframes, eCCE k (k=0, . . . , 3) within each PRB pair could be formed by grouping 4 eREGs k+4i for localized allocations, where each eREG i=0, . . . , is from the same PRB pair, and/or eCCE k (k=0, . . . , 15) across four PRB pairs could be formed by grouping 4 eREGs (k+4i) mod 16 for distributed allocations, where each eREG i=0, . . . , 3 is from a different PRB pair.

With the first option, i.e. the CSS-Config information element consisting of 5 bits, it may be predefined that the CSS-eCCEmappingtoPRB is (always) the distributed eCCE mapping to PRB pairs or the localized eCCE mapping to PRB pairs. Under the assumption that a distributed mapping is safer (e.g. in terms of detection probability, since the localized mapping may cause that the CSS occurs in an UE's deep fading hole in frequency), an “always-distributed” definition could be effective. Thereby, 1 bit could be saved as compared with the second option.

In view of the above, the eNB is configured to generate the parameter “CSS-Resource” or both the parameters “CSS-Resource” and “CSS-eCCEmappingtoPRB” in accordance with the configured CSS so as to reflect the CSS configuration, and to generate the MIB using the CSS-Config information element on the basis of the thus generated parameters.

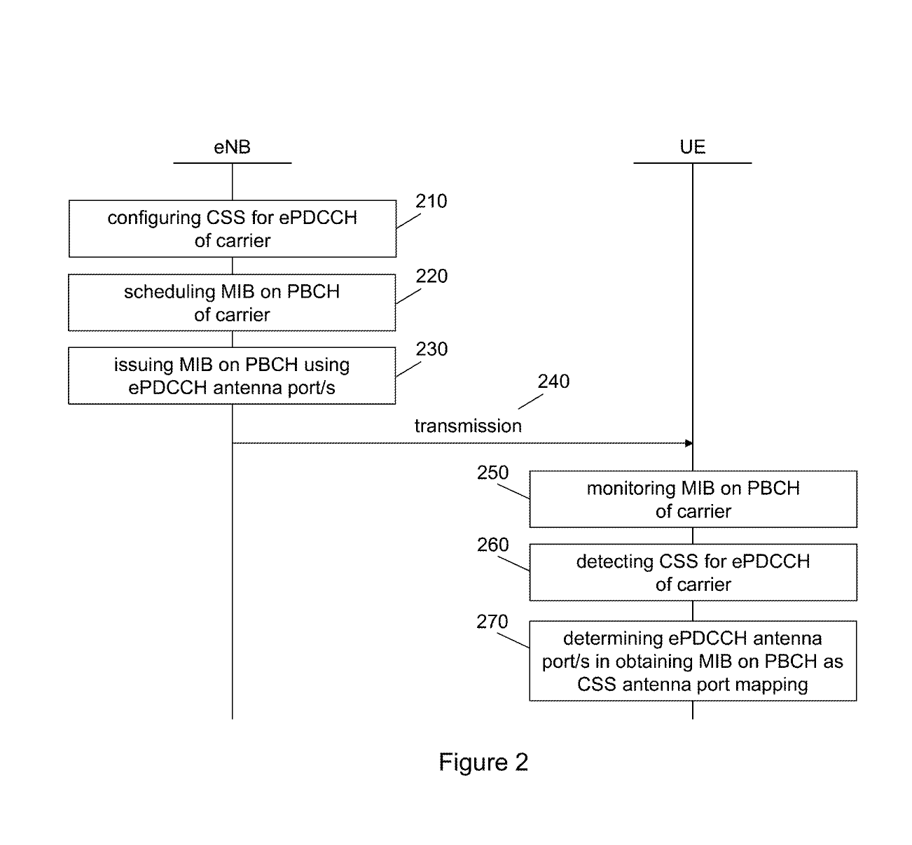

FIG. 2 shows a signaling diagram illustrating a second example procedure of according to some example embodiments of the present invention.

As shown in FIG. 2, an example procedure according to some example embodiments of the present invention may include the following operations. The thus exemplified procedure is applicable between a base station such as an eNB and a terminal such as an UE in a cellular communication system such as a LTE/LTE-A communication system. The operations 210, 220, 240, 250 and 260 according to FIG. 2 may basically correspond to the operations 110 to 150 according to FIG. 1, respectively. Hence, a description thereof is not repeated, but reference is made to the above description of FIG. 1 accordingly.

At the network side, the eNB may additionally issue (or, initiate transmission of) the scheduled master information block (MIB) on the physical broadcast channel (PBCH) using at least one antenna port of the ePDCCH (operation 230). Then, a transmission from the eNB to the UE may be accomplished using the PBCH of the carrier and the at least one antenna port (operation 240). At the terminal side, the UE may additionally obtain (after receiving) the master information block (MIB) on the physical broadcast channel (PBCH) using the at least one antenna port of the ePDCCH (operation 270), wherein the at least one antenna port is determined as an antenna port mapping of the ePDCCH in the CSS.

Accordingly, by the eNB, the MIB may be transmitted on the PBCH mapped to antenna ports used by the ePDCCH in the CCS. At the UE, the MIB can be used (i) to check no erroneous PSS/SSS detection using MIB CRC and (ii) to determine implicitly the ePDCCH antenna ports used in CSS, i.e. the CSS antenna port mapping.

With respect to FIG. 2, it is noted that the depicted sequence of operations is only for illustrative purposes but does not necessarily have to be as depicted. For example, the operation 270 could equally be realized prior to the operation 260.

According to some example embodiments of the present invention, the CSS configuration could include such CSS antenna port mapping. Accordingly, the eNB could configure and the UE could determine such CSS antenna port mapping.

The antenna port or ports used by the MIB on the subject carrier could be determined by the UE when blindly detecting the MIB on the PBCH. The UE could try each antenna port (AP), e.g. {AP#7, AP#8, AP#9, AP#10} or a combination of two antenna ports (AP#7, AP#9) or {AP#8, AP#10}.

In this regard, it could be assumed that layer mapping and precoding for the MIB is applied, as specified in section 6.6.3 of 3GPP TS 36.221 (V 10.4.0) for the Rel-8/9/10 MIB, as outlined below:

The block of modulation symbols d(0), . . . , d(M_{symb}−1) shall be mapped to layers according to one of Sections 6.3.3.1 or 6.3.3.3 with M_{symb}⁽⁰⁾=M_{symb} and precoded according to one of Sections 6.3.4.1 or 6.3.4.3, resulting in a block of vectors y(i)=[y⁽⁰⁾(i) . . . y^{(P-1)}(i)]^{T}, i=0, . . . , M_{symb}−1, where y^{(p)}(i) represents the signal for antenna port p and where p=0, . . . , P−1 and the number of antenna ports for cell-specific reference signals Pε{1,2,4}.

In a first option according to some example embodiments of the present invention, the layer mapping and precoding used for the MIB transmission on the subject carrier may be similarly done as in the aforementioned specification for a single antenna port with antenna port AP#7, AP#8, AP#9, or AP#10 instead of antenna port AP#0.

In a second option according to some example embodiments of the present invention, transmit diversity with the number of spatial layers equal to two antenna ports may be similarly done as in the aforementioned specification with antenna ports AP#7 and AP#9 or antenna ports AP#8 and AP#10 instead of antenna ports AP#0 and AP#1.

The antenna port or ports used by the ePDCCH in the CSS could be determined implicitly to be the same as the antenna port or ports used for the MIB transmission on the subject carrier, as outlined above.

According to some example embodiments of the present invention, the antenna port mapping could be specified on a cell basis on the basis of a cell configuration. For example, the CSS antenna port mapping may be configured on the basis of a physical cell identity with or without consideration of the system bandwidth (or a number of PRB subsets in the system bandwidth). That is to say, the E-UTRAN may coordinate the mapping of antenna ports such that multiple (neighboring) eNBs may use different antenna ports for the ePDCCH in the CSS. Such CSS antenna port mapping may result in a coordination of common search spaces.

Namely, using a cell configuration such as the physical cell identity being assigned by/in the E-UTRAN, a coordination of CSS antenna port mappings between multiple cells/eNBs is enabled. Thereby, inter-cell interference on the common control signaling between such cells/eNBS may be mitigated. Such antenna port mapping may be achieved by the eNBs via the X2 interface between the individual eNBs.

The E-UTRAN may assign, or in the E-UTRAN there may be assigned, physical cell identities to multiple (neighboring) cells to ensure that their CSS antenna port mappings (and their MIB/SIB transmissions) are separated, as much as can be. In this regard, configuration of the ePDCCH CSS antenna port mappings can be coordinated between multiple eNBs to limit inter-cell interference to the ePDCCH in the CSS.

In a larger bandwidth configuration, it may also be possible to allocate different subsets of PRBs or PRB pairs to multiple (neighboring) eNBs. This may be accomplished by way of indication in the aforementioned CSS-Config information element in the MIB with the parameter “CSS-eCCEmappingtoPRB” configuring a localized eCCE mapping to PRB pairs. For example, it may be indicated that some PRB subset other than a middle PRB subset, e.g. middle 6 PRBs, is configured for a specific eNB, thus achieving a dispersion of PRB subsets of multiple (neighboring) eNBs. Such PRB subset configuration could also be based on some cell configuration, such as a physical cell identity. Thereby, inter-cell interference to the ePDCCH in the CSS may be further mitigated. Accordingly, a L1 signaling optimization between eNBs/cells could be realized, which could be achieved via the X2 interface between the individual eNBs, while the S1 interface between any eNB and the EPC may not be affected.

With respect to FIGS. 1 and 2, although not illustrated therein, the eNB at the network side may also configure an UE-specific search space (USS) for the ePDCCH of the subject carrier.

Once the UE has been configured with the CSS configuration, i.e. the PRB pair set for the CSS (according to the procedure of FIG. 1) and/or the antenna mapping for CSS (according to the procedure of FIG. 2), the eNB could configure at least one PRB pair set and antenna port mapping for the USS of a specific UE. Such USS configuration could be realized via dedicated signaling on the DL-SCH using the ePDCCH on the previously configured CSS. The ePDCCH in the USS can be configured to be mapped to different antenna ports based on the C-RNTI in case of overlapping CSS and USS, or some other way.

By way of dedicated signaling on the DL-SCH using the ePDCCH on the CSS or using the ePDCCH on the USS, an initial cell access procedure of a subject UE could be completed. Then, data scheduling on the user plane may be carried out following the initial cell access.

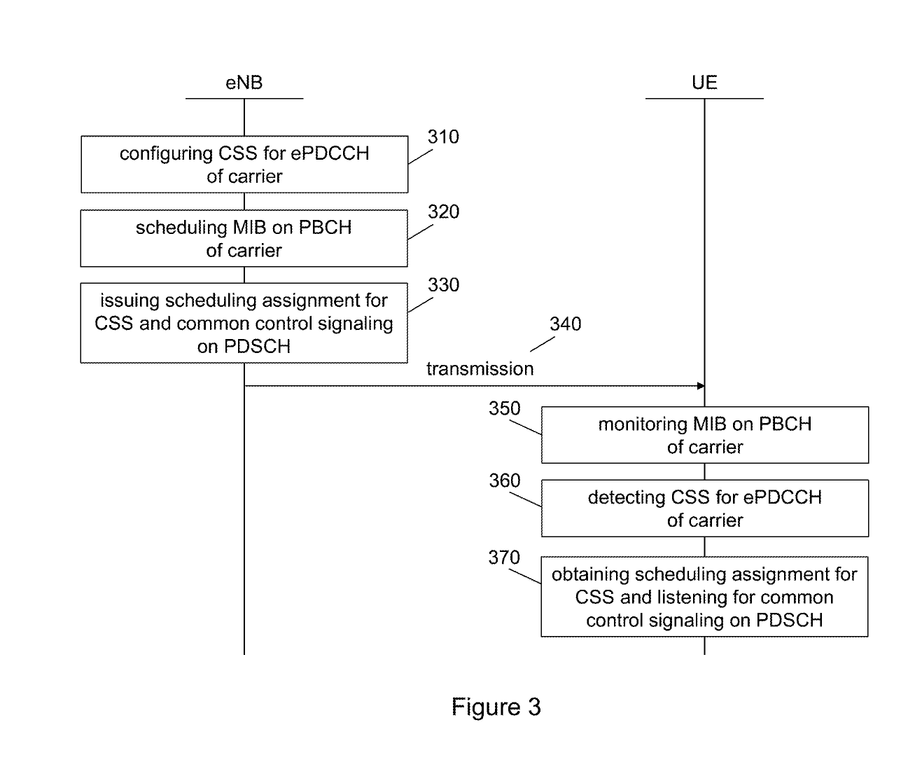

FIG. 3 shows a signaling diagram illustrating a third example procedure of according to some example embodiments of the present invention.

As shown in FIG. 3, an example procedure according to some example embodiments of the present invention may include the following operations. The thus exemplified procedure is applicable between a base station such as an eNB and a terminal such as an UE in a cellular communication system such as a LTE/LTE-A communication system. The operations 310, 320, 340, 350 and 360 according to FIG. 3 may basically correspond to the operations 110 to 150 according to FIG. 1, respectively. Hence, a description thereof is not repeated, but reference is made to the above description of FIG. 1 accordingly.

At the network side, the eNB may additionally issue (or, initiate transmission of) a scheduling assignment for common control signaling on the ePDCCH in the configured common search space, and issue (or, initiate transmission of) common control signaling on a physical downlink shared channel (PDSCH) in accordance with the scheduling assignment (operation 330). Then, a transmission from the eNB to the UE may be accomplished using the PBCH of the carrier in accordance with the scheduling assignment (operation 340). At the terminal side, the UE may additionally obtain the scheduling assignment for common control signaling on the ePDCCH in the detected common search space, and listen for (or monitor) common control signaling on the PDSCH in accordance with the obtained scheduling assignment.

The aforementioned common control signaling (i.e. system information or broadcast information) and their scheduling/transmission may be as follows.

Generally, the synchronization of a carrier transmission could be as specified for legacy carriers.

Accordingly, a specified synchronization signal, such as PSS/SSS, may be used for synchronization. Re-using such specified synchronization signal is applicable for an application to a new carrier type, as described above. This is because a standalone carrier of such new carrier type is not aggregated with any legacy carrier, and hence it cannot be assumed to be pre-synchronized based on a synchronization of/to the legacy carrier. Further, requirements for synchronization on a standalone carrier of such new carrier type are assumed to be similar to that for a legacy carrier.

In detecting the transmission, the UE may detect a synchronization signal, and may detect the MIB after detection of the synchronization signal. For example, the UE tries a blind MIB detection in the middle 6-PRB subset or each 6-PRB subset in the system bandwidth following a PSS/SSS detection in the middle 6-PRB subset, and checks whether or not there was an erroneous PSS/SSS detection using MIB CRC. A false detection is avoided by a fixed timing of the MIB relative to PSS/SSS, MIB CRC checking, and scrambling of payload with the physical cell identity.

Firstly, a system information block of the common control signaling, i.e. SIBx (x=1, 2, . . . ) in System Information (SI) messages, could be scheduled and transmitted by the eNB on the PDSCH (being scrambled with SI-RNTI) in accordance with DL grant on the ePDCCH in the CSS, and it may be listened for (or monitored) and obtained by the UE accordingly. The UE may detect the SIBx which is contained in S1 messages transmitted on the PDSCH as indicated by DL grant on the ePDCCH in the CSS. In this regard, UEs blindly decode the ePDCCH in the CSS and check the CRC of the ePDCCH which is scrambled with SI-RNTI. The SIB1 is located in a fixed time domain position. The SIBx (x=2, 3, 4, . . . ) are transmitted periodically in non-overlapping time-domain SI windows. The length of SI windows, the periodicity of SI windows, and a list of SIBx (x=3, 4, . . . ) scheduled in the SI windows is indicated in SIB1, while the SIB2 is not listed in SIB1 because of being always transmitted in the first entry of the first SI message.

Secondly, a paging message could be scheduled and transmitted by the eNB on the PDSCH (being scrambled with P-RNTI) in accordance with DL grant on the ePDCCH in the CSS, and it may be listened for (or monitored) and obtained by the UE accordingly. The UE may detect the paging message transmitted on the PDSCH as indicated by DL grant on the ePDCCH in the CSS. In this regard, UEs blindly decode the ePDCCH in the CSS and check the CRC of ePDCCH which is scrambled with P-RNTI.

Thirdly, a RACH response message could be scheduled and transmitted by the eNB on the PDSCH (being scrambled with RA-RNTI) in accordance with DL grant on the ePDCCH in the CSS, and it may be listened for (or monitored) and obtained by the UE accordingly. The UE may detect the RACH response message transmitted on the PDSCH as indicated by DL grant on the ePDCCH in the CSS. In this regard, UEs blindly decode the ePDCCH in the CSS and check the CRC of ePDCCH which is scrambled with RA-RNTI.

Fourthly, a transmit power control (TPC) message could be scheduled and transmitted by the eNB on the PDSCH (being scrambled with TPC-RNTI) in accordance with DL grant on the ePDCCH in the CSS, and it may be listened for (or monitored) and obtained by the UE accordingly. The UE may detect the transmit power control (TPC) message transmitted on the PDSCH as indicated by DL grant on the ePDCCH in the CSS. In this regard, UEs blindly decode the ePDCCH in the CSS and check the CRC of ePDCCH which is scrambled with TPC-RNTI.

With respect to FIG. 3, it is noted that the depicted sequence of operations is only for illustrative purposes but does not necessarily have to be as depicted. For example, the operation 370 could equally be realized prior to the operation 350 or prior to the operation 360.

With respect to FIGS. 2 and 3, it is noted that the thus illustrated example procedures could also be combined. That is to say, a procedure according to some example embodiments of the present invention could include a configuring operations 210/310, a scheduling operation 220/320, an issuing operation 230, an issuing operation 330, a transmission 240/340, a monitoring operation 250/350, a detecting operation 260/360, a determining operation 270 and an obtaining/listening operation 370 according to the foregoing description of FIGS. 2 and 3. In this regard, the sequence of operations 230 and 330 and operations 270 and 370 is arbitrary.

As outlined above, by virtue of at least some example embodiments of the present invention, there is provided a common search space configuration of a standalone carrier. At least when such common search space configuration is based on a cell configuration, it is effective for reducing inter-cell interference to the ePDCCH in the common search space.

Such common search space configuration according to at least some example embodiments of the present invention is applicable LTE/LTE-A Rel-11, Rel-12 and/or onwards. More specifically, such common search space configuration according to at least some example embodiments of the present invention is exemplarily applicable for a standalone carrier/operation of a non-backwards compatible LTE/LTE-A carrier type for carrier aggregation, for enhancements of which it may be taken advantage of the lacking requirement of support of legacy terminals.

Accordingly, one or more of an effective and efficient CSS configuration (without the need of dedicated signaling on the DL-SCH or the PDCCH), an implicit determination of ePDCCH antenna ports used in the CSS on a standalone carrier based on MIB detection, an indication of CSS and eCCE mapping to PRB pair in a MIB on the PBCH, and inter-cell interference coordination on the CSS may be realized.

A standalone carrier/operation of a non-backwards compatible LTE/LTE-A carrier type for carrier aggregation, i.e. a new carrier type, supports non-CA terminals, and provides for relaxed RF requirements and lower costs (thus providing an advantage in view of the fact that current pico cell requirements are as strict as macro cell requirements), as well as for standalone local access (i.e. all connections from a local-access node) and lean macro cells e.g. in rural areas (i.e. more efficient downlink signaling).

A standalone carrier/operation of a non-backwards compatible LTE/LTE-A carrier type for carrier aggregation, i.e. a new carrier type, for which a common search space configuration according to at least some example embodiments of the present invention is applied, does not require use of the DL-SCH and, thus, the PDCCH. Accordingly, only support of the ePDCCH is required for such configured carrier.

Generally, the above-described procedures and functions may be implemented by respective functional elements, processors, processing systems, or the like, as described below.

While in the foregoing some example embodiments of the present invention are described mainly with reference to methods, procedures and functions, corresponding example embodiments of the present invention also cover respective apparatuses, network nodes and systems, including both software and/or hardware thereof.

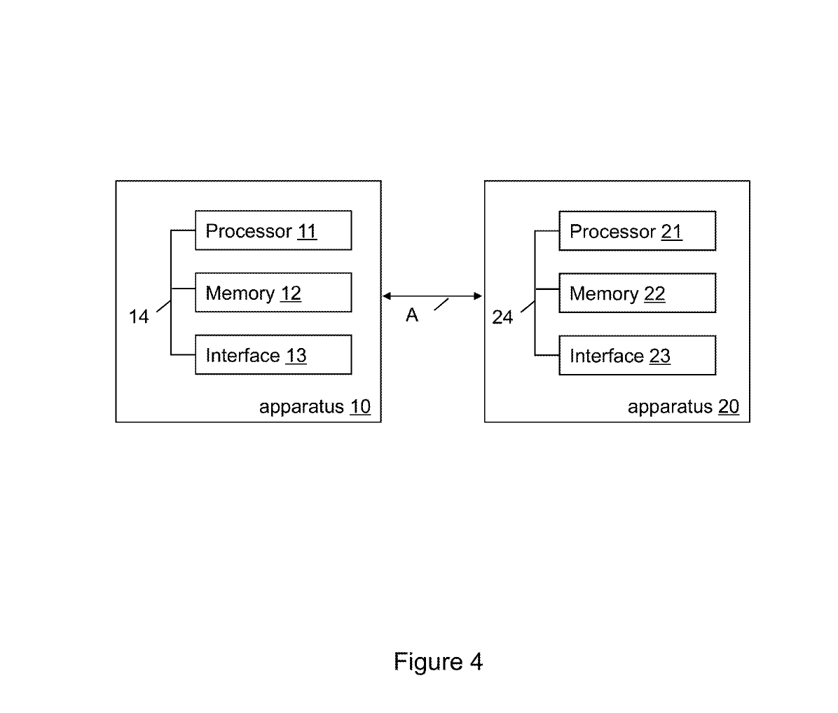

Respective some example embodiments of the present invention are described below referring to FIG. 4, while for the sake of brevity reference is made to the detailed description with regard to FIGS. 1 to 3.

In FIG. 4 below, which is noted to represent a simplified block diagram, the solid line blocks are basically configured to perform respective operations as described above. The entirety of solid line blocks are basically configured to perform the methods and operations as described above, respectively. With respect to FIG. 4, it is to be noted that the individual blocks are meant to illustrate respective functional blocks implementing a respective function, process or procedure, respectively. Such functional blocks are implementation-independent, i.e. may be implemented by means of any kind of hardware or software, respectively. The arrows and lines interconnecting individual blocks are meant to illustrate an operational coupling there-between, which may be a physical and/or logical coupling, which on the one hand is implementation-independent (e.g. wired or wireless) and on the other hand may also include an arbitrary number of intermediary functional entities not shown. The direction of arrow is meant to illustrate the direction in which certain operations are performed and/or the direction in which certain data is transferred.

Further, in FIG. 4, only those functional blocks are illustrated, which may relate to any one of the above-described methods, procedures and functions. A skilled person will acknowledge the presence of any other conventional functional blocks required for an operation of respective structural arrangements, such as e.g. a power supply, a central processing unit, respective memories or the like. Among others, memories are provided for storing programs or program instructions for controlling the individual functional entities to operate as described herein.

FIG. 4 shows a schematic block diagram illustrating example apparatuses according to some example embodiments of the present invention.

In view of the above, the thus illustrated apparatuses 10 and 20 are suitable for use in practicing example embodiments of the present invention, as described herein.

The thus illustrated apparatus 10 corresponds to an entity which may represent a (or part of a) communication control device such as a base station, e.g. an eNB, or a corresponding modem (which may be installed as part thereof, but may be also a separate module, which can be attached to various devices), and may be configured to perform a procedure and/or functionality as described in conjunction with any one of FIGS. 1 to 3. The thus illustrated apparatus 20 corresponds to an entity which may represent a (or part of a) communication device such as a terminal, e.g. an UE, or a corresponding modem (which may be installed as part thereof, but may be also a separate module, which can be attached to various devices), and may be configured to perform a procedure and/or functionality as described in conjunction with any one of FIGS. 1 to 3.

Generally, any apparatus according to some example embodiments of the present invention may include at least one processor, at least one memory including computer program code, and at least one interface (or transceiver) configured for communication with at least another apparatus. Further, in any apparatus according to some example embodiments of the present invention, at least one processor and at least one memory including computer program code, wherein the at least one processor, with the at least one memory and the computer program code, is configured to cause the apparatus to perform as described herein, may be considered as a processing system.

As indicated in FIG. 4, according to some example embodiments of the present invention, an apparatus includes one or more processors 11/21 and one or more memories 12/22, and may also include one or more interface(s) 13/23, which may be connected by a bus 14/24 or the like. Further, apparatuses may be connected via a corresponding link or connection A.

The processor(s) 11/21 and/or the interface(s) 13/23 may be facilitated for communication over a (hardwire or wireless) link, respectively. The interface(s) 13/23 may include a suitable receiver or a suitable transmitter-receiver combination or transceiver, which is coupled to one or more antennas or communication means for (hardwire or wireless) communications with the linked or connected device(s), respectively. The interface(s) 13/23 may be generally configured to communicate with another apparatus, i.e. the interface thereof.

The memory/memories 12/22 may store respective programs assumed to include program instructions or computer program code that, when executed by the respective processor, enables the respective electronic device or apparatus to operate in accordance with example embodiments of the present invention. For example, the memory/memories 12/22 of the apparatus 10/20 may store information on an arrangement of PRB subsets in the system bandwidth, or the like.

In general terms, the respective devices/apparatuses (and/or parts thereof) may represent means for performing respective operations and/or exhibiting respective functionalities, and/or the respective devices (and/or parts thereof) may have functions for performing respective operations and/or exhibiting respective functionalities.

When in the subsequent description it is stated that a processor or processing system (or some other means) is configured to perform some function, this is to be construed to be equivalent to a description stating that at least one processor, potentially in cooperation with computer program code stored in the memory of the respective apparatus, is configured to cause the apparatus to perform at least the thus mentioned function. Also, such function is to be construed to be equivalently implementable by specifically configured means for performing the respective function (i.e. the expression “processor configured to [cause the apparatus to] perform xxx-ing” is construed to be equivalent to an expression such as “means for xxx-ing”).

In its most basic form, according to some example embodiments of the present invention, the apparatus 10 or its processor 11 (i.e. a processing system thereof) is configured to perform configuring a common search space for an enhanced physical downlink control channel of a carrier, and scheduling a master information block of common control signaling on a physical broadcast channel of the carrier, wherein said master information block indicates a configuration of the common search space which defines a set of pairs of physical resource blocks in the common search space.

Accordingly, stated in other words, the apparatus 10 at least includes respective means for configuring a common search space and means for scheduling a master information block of common control signaling on a physical broadcast channel.

In its most basic form, according to some example embodiments of the present invention, the apparatus 20 or its processor 21 (i.e. a processing system thereof) is configured to perform monitoring a master information block of common control signaling on a physical broadcast channel of a carrier, wherein said master information block indicates a configuration of a common search space which defines a set of pairs of physical resource blocks in the common search space, and detecting the common search space for an enhanced physical downlink control channel of the carrier on the basis of the configuration of the common search space indicated in the monitored master information block.

Accordingly, stated in other words, the apparatus 20 at least includes respective means for monitoring a master information block of common control signaling on a physical broadcast channel and means for detecting a common search space for an enhanced physical downlink control channel.

For further details of specifics regarding functionalities according to some example embodiments of the present invention, reference is made to the foregoing description in conjunction with FIGS. 1 to 3.

According to some example embodiments of the present invention, a system may include any conceivable combination of the thus depicted devices/apparatuses and other network elements, which are configured to cooperate as described above.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any structural means such as a processor or other circuitry may refer to one or more of the following: (a) hardware-only circuit implementations (such as implementations in only analog and/or digital circuitry) and (b) combinations of circuits and software (and/or firmware), such as (as applicable): (i) a combination of processor(s) or (ii) portions of processor(s)/software (including digital signal processor(s)), software, and memory(ies) that work together to cause an apparatus, such as a mobile phone or server, to perform various functions) and (c) circuits, such as a microprocessor(s) or a portion of a microprocessor(s), that require software or firmware for operation, even if the software or firmware is not physically present. Also, it may also cover an implementation of merely a processor (or multiple processors) or portion of a processor and its (or their) accompanying software and/or firmware, any integrated circuit, or the like.

Generally, any procedural step or functionality is suitable to be implemented as software or by hardware without changing the idea of the present invention. Such software may be software code independent and can be specified using any known or future developed programming language, such as e.g. Java, C++, C, and Assembler, as long as the functionality defined by the method steps is preserved. Such hardware may be hardware type independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components. A device/apparatus may be represented by a semiconductor chip, a chipset, system in package, or a (hardware) module including such chip or chipset; this, however, does not exclude the possibility that a functionality of a device/apparatus or module, instead of being hardware implemented, be implemented as software in a (software) module such as a computer program or a computer program product including executable software code portions for execution/being run on a processor. A device may be regarded as a device/apparatus or as an assembly of more than one device/apparatus, whether functionally in cooperation with each other or functionally independently of each other but in a same device housing, for example.

Apparatuses and/or means or parts thereof can be implemented as individual devices, but this does not exclude that they may be implemented in a distributed fashion throughout the system, as long as the functionality of the device is preserved. Such and similar principles are to be considered as known to a skilled person.

Software in the sense of the present description includes software code as such including code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present invention also covers any conceivable combination of method steps and operations described above, and any conceivable combination of nodes, apparatuses, modules or elements described above, as long as the above-described concepts of methodology and structural arrangement are applicable.

In view of the above, some examples of the present invention provide measures for a common search space configuration of a standalone carrier. Such measures may exemplarily include measures for configuring a common search space for an enhanced physical downlink control channel of a carrier, and measures for scheduling a master information block of common control signaling on a physical broadcast channel of the carrier, wherein said master information block indicates a configuration of the common search space which defines a set of pairs of physical resource blocks in the common search space.

Even though some examples of the present invention are described above with reference to the examples according to the accompanying drawings, it is to be understood that they are not restricted thereto. Rather, it is apparent to those skilled in the art that the present invention can be modified in many ways without departing from the scope of the inventive idea as disclosed herein.

### LIST OF ACRONYMS AND ABBREVIATIONS

3GPP Third Generation Partnership Project
ARQ Automatic Repeat Request
CA Carrier Aggregation
CC Component Carrier
CCE Channel Control Element
C-RNTI Connection RNTI
CRC Cyclic Redundancy Check
CRS Common Reference Signal
CSS Common Search Space
DL Downlink
DL-SCH DL Shared Channel
DM RS Demodulation Reference Signal
eCCE enhanced CCE (CCE of ePDCCH)
eNB evolved Node B (E-UTRAN base station)
EPC Evolved Packet Core
ePDCCH Enhanced Physical Downlink Control Channel
eREG enhanced REG (REG of ePDCCH)
E-UTRAN Evolved UTRAN
IEEE Institute of Electrical and Electronics Engineers
LTE Long Term Evolution
LTE-A Long Term Evolution Advanced
MIB Master Information Block
MIMO Multiple Input Multiple Output
NCT New Carrier Type
OFDM Orthogonal Frequency Division Multiplexing
PBCH Physical Broadcast CHannel
PCC Primary Cell Carrier
PCI Physical Cell Identity
PDCCH Physical Downlink Control CHannel
PDSCH Physical Downlink Shared Channel
PHICH Physical Hybrid-ARQ Indicator Channel
PRB Physical Resource Block
P-RNTI Paging RNTI
PSS Primary Synchronization Signal
RNTI Radio Network Temporary Identifier
RACH Random Access Channel
RA-RNTI Radio Access RNTI
RCRS Reduced Cell-specific Reference Signal
RE Resource Element
REG Resource Element Group
RF Radio Frequency
RRC Radio Resource Control
RS Reference Signal
SCC Secondary Cell Carrier
SI System Information
SIB System Information Block
SI-RNTI System Information RNTI
SNR Signal to Noise Ratio
SSS Secondary Synchronization Signal
TPC Transmit Power Control
TPC-RNTI Transmit Power Control RNTI
UE User Equipment
UL Uplink
USS UE-specific Search Space
UTRAN UMTS Terrestrial Radio Access Network
UMTS Universal Mobile Telecommunications System

1. A method comprising:
configuring a common search space for an enhanced physical downlink control channel of a carrier, and
scheduling a master information block of common control signaling on a physical broadcast channel of the carrier, wherein said master information block indicates a configuration of the common search space which defines a set of pairs of physical resource blocks in the common search space.

2. The method according to claim 1, wherein a number of physical resource blocks in said set of pairs of physical resource blocks in the common search space is configured, said configuration of the common search space comprising said number of physical resource blocks in said set of pairs of physical resource blocks in the common search space.

3. The method according to claim 2, wherein a mapping of localized or distributed control channel elements of the enhanced physical downlink control channel to said pairs of physical resource blocks in the common search space is configured, said configuration of the common search space further comprising an indication of said mapping of localized or distributed control channel elements of the enhanced physical downlink control channel to said pairs of physical resource blocks in the common search space.

4. The method according to claim 1, wherein the common search space is configured on a cell basis on the basis of a cell configuration.

5. The method according to claim 1, further comprising at least one of:
issuing the scheduled master information block on the physical broadcast channel using at least one antenna port of the enhanced physical downlink control channel;
issuing a scheduling assignment for common control signaling on the enhanced physical downlink control channel in the configured common search space; and
issuing common control signaling on a physical downlink shared channel in accordance with the scheduling assignment.

6. The method according to claim 5, wherein at least one of:
mapping of the at least one antenna port is specified on a cell basis on the basis of a cell configuration;
the method is operable at or by a base station of a cell of a cellular communication system; and/or
the carrier comprises a standalone carrier of a non-backwards compatible carrier type and/or is usable as a component carrier in carrier aggregation.

7. A method comprising:
monitoring a master information block of common control signaling on a physical broadcast channel of a carrier, wherein said master information block indicates a configuration of a common search space which defines a set of pairs of physical resource blocks in the common search space, and
detecting the common search space for an enhanced physical downlink control channel of the carrier on the basis of the configuration of the common search space indicated in the monitored master information block.

8. The method according to claim 7, wherein a number of physical resource blocks in said set of pairs of physical resource blocks in the common search space is detected on the basis of the configuration of the common search space indicated in the monitored master information block.

9. The method according to claim 8, wherein a mapping of localized or distributed control channel elements of the enhanced physical downlink control channel to said pairs of physical resource blocks in the common search space is detected on the basis of the configuration of the common search space indicated in the monitored master information block.

10. The method according to claim 7, further comprising at least one of:
obtaining the master information block on the physical broadcast channel using at least one antenna port of the enhanced physical downlink control channel, wherein said at least one antenna port is determined as an antenna port mapping of the enhanced physical downlink control channel in the common search space;
obtaining a scheduling assignment for common control signaling on the enhanced physical downlink control channel in the detected common search space; and
listening for common control signaling on a physical downlink shared channel in accordance with the obtained scheduling assignment.

11. The method according to claim 7, wherein
the method is operable at or by a terminal operable in a cell of a cellular communication system, and/or
the carrier comprises a standalone carrier of a non-backwards compatible carrier type and/or is usable as a component carrier in carrier aggregation.

12. An apparatus for use on a network side of a cellular communication system, comprising a processing system arranged to cause the apparatus to perform:
configuring a common search space for an enhanced physical downlink control channel of a carrier, and
scheduling a master information block of common control signaling on a physical broadcast channel of the carrier, wherein said master information block indicates a configuration of the common search space which defines a set of pairs of physical resource blocks in the common search space.

13. The apparatus according to claim 12, wherein the processing system is arranged to cause the apparatus to at least one of:
configure a number of physical resource blocks in said set of pairs of physical resource blocks in the common search space, and to include said number of physical resource blocks in said configuration of the common search space;
configure a mapping of localized or distributed control channel elements of the enhanced physical downlink control channel to said pairs of physical resource blocks in the common search space, and to include said mapping in said configuration of the common search space;
configure the common search space on a cell basis on the basis of a cell configuration; and
perform issuing the scheduled master information block on the physical broadcast channel using at least one antenna port of the enhanced physical downlink control channel.

14. The apparatus according to claim 13, wherein the processing system is arranged to cause the apparatus to specify the mapping of the at least one antenna port on a cell basis on the basis of a cell configuration.

15. The apparatus according to claim 12, wherein at least one of:
the processing system is arranged to cause the apparatus to perform issuing a scheduling assignment for common control signaling on the enhanced physical downlink control channel in the configured common search space, and issuing common control signaling on a physical downlink shared channel in accordance with the scheduling assignment;
the apparatus is operable as or at a base station of a cell of a cellular communication system;
the carrier comprises a standalone carrier of a non-backwards compatible carrier type and/or is usable as a component carrier in carrier aggregation; and
the cellular communication system comprises a Long Term Evolution (LTE) or Long Term Evolution Advanced (LTE-A) communication system.

16. An apparatus for use on a terminal side of a cellular communication system, comprising a processing system arranged to cause the apparatus to perform:
monitoring a master information block of common control signaling on a physical broadcast channel of a carrier, wherein said master information block indicates a configuration of a common search space which defines a set of pairs of physical resource blocks in the common search space, and
detecting the common search space for an enhanced physical downlink control channel of the carrier on the basis of the configuration of the common search space indicated in the monitored master information block.

17. The apparatus according to claim 16, wherein the processing system is arranged to cause the apparatus to at least one of:
detect a number of physical resource blocks in said set of pairs of physical resource blocks in the common search space on the basis of the configuration of the common search space indicated in the monitored master information block;
obtain the master information block on the physical broadcast channel using at least one antenna port of the enhanced physical downlink control channel, wherein the processing system is arranged to cause the apparatus to determine said at least one antenna port as an antenna port mapping of the enhanced physical downlink control channel in the common search space;
obtain a scheduling assignment for common control signaling on the enhanced physical downlink control channel in the detected common search space; and
listen for common control signaling on a physical downlink shared channel in accordance with the obtained scheduling assignment.

18. The apparatus according to claim 17, wherein the processing system is arranged to cause the apparatus to detect a mapping of localized or distributed control channel elements of the enhanced physical downlink control channel to said pairs of physical resource blocks in the common search space on the basis of the configuration of the common search space indicated in the monitored master information block.

19. The apparatus according to claim 16, wherein
the apparatus is operable as or at a terminal operable in a cell of a cellular communication system, and/or
the carrier comprises a standalone carrier of a non-backwards compatible carrier type and/or is usable as a component carrier in carrier aggregation.

20. The apparatus according to claim 19, wherein
the cellular communication system comprises a Long Term Evolution (LTE) or Long Term Evolution Advanced (LTE-A) communication system.

21. A non-transitory computer-readable storage medium comprising computer program code which when executed by a data processing system, causes the data-processing system to carry out the method according to claim 1.
